(19) United States
(12) Patent Application Publication
(10) Pub. No.: US 2011/0000861 A1
(43) Pub. Date: Jan. 6, 2011

(54) Portable and Scalable Water Reclamation System and Method

(75) Inventors: Nathan R. Hutchings, Shreveport, LA (US); Eric W. Appleton, Shreveport, LA (US)

Correspondence Address: BRACEWELL & GIULIANI LLP, P.O. BOX 61389, HOUSTON, TX, 77208-1389, US

(73) Assignee: Bear Creek Services, LLC., Shreveport, LA (US)

(21) Appl. No.: 12/830,073

(22) Filed: Jul. 2, 2010

Related U.S. Application Data
(60) Provisional application No. 61/223,128, filed on Jul. 6, 2009.

(51) Int. Cl. C02F 1/00; C02F 1/68

(52) U.S. Cl. 210/749; 210/241; 210/200; 210/240; 210/790; 210/806

(57) ABSTRACT

An embodiment of a water reclamation system has at least one water filtration module mounted to a transport vehicle. The at least one water filtration module has a plurality of water treatment vessels with a treatment media positioned therein. A waste water inlet header, a produced water collection header, and a waste water outlet header are all connected to the plurality of water treatment vessels of the at least one water filtration module. A method of reclaiming waste water comprises flowing waste water into the waste water inlet header where it is distributed into the plurality of treatment vessels. The waste water engages the treatment media and the filtered or produced water is collected in the produced water collection header. The waste water is collected in the waste water outlet header.

### CROSS REFERENCE TO RELATED APPLICATIONS

This application claims the benefit of and priority to U.S. Provisional Patent Application No. 61/223,128, filed on Jul. 6, 2009, and herein incorporated by reference in its entirety.

### FIELD OF THE INVENTION

The present invention relates to water reclamation, and in particular, to a portable and scalable water reclamation system and method.

### BACKGROUND OF THE INVENTION

Fresh water and affordable energy are two of the most valuable resources on the planet for sustaining economic growth and development. As the demand for oil and gas continues to increase, the consumption of fresh water by exploration and production activities is skyrocketing. Competition for fresh water is becoming an industry-limiting factor in some geography. To ensure that the fresh water needed by the oil and gas industry is available in the future, better water resource management practices must by implemented.

Currently, the drilling, completion, and stimulation of each horizontal shale well consumes up to 10 million gallons of fresh water, roughly equal to daily water usage of 144,000 people. Once fresh water becomes oilfield waste, the water is typically disposed of into reservoirs below the fresh water table, permanently removing it from the fresh water cycle. Reusing the water is desirable but often presents technical problems with water quality, water management logistics, and cost.

Water for use in the oil and gas industry is most commonly acquired from surface waters (lakes, ponds, and streams), aquifers (on-site water well), or through the local municipal water supplies. Fresh water is used throughout the process of drilling and completing a well. Once the water has been used in exploration and production activities, the water becomes one of three types of oilfield waste water: drilling waste, completion flow back, or production (geological) saltwater.

During the drilling phase, fresh water is used as the solute and suspension medium for the drilling mud, which draws the cuttings away from the drill bit, stabilizes the well bore, and cools the bit while drilling. In a typical open-loop system, the mud is circulated by pumps on the drilling rig and the waste water, cuttings, and mud are discharged into the reserve pit, typically a 5,000-25,000 barrel earthen pit adjacent to the drilling rig. Occasionally, the waste fluids in one reserve pit are reused on another drilling location or allowed to settle and discharged onto the land surrounding the well (permitted in limited situations only). Both of these waste disposal practices are currently under tight scrutiny and are becoming less of an option for oil drilling companies. When surface discharge or transfer to another pit is not an option, the waste water must be either injected into the well bore or hauled to a disposal well. Like surface discharge, down hole injection is being tightly regulated, and hauling the waste for disposal is expensive. While injecting the water below the freshwater aquifer protects the ground water from contamination from the exploration and production waste, deep well injection permanently removes the waste water from the fresh water cycle. Further, injecting the water below the freshwater aquifer creates added pressure on underground formations. Although the total dissolved solutes (TDS) in water-based drilling waste is typically less than 5,000 ppm, the primary contaminants in drilling waste that are undesirable to carry forward into reclaimed water for reuse are colloidal suspended solids, hydrocarbons, and heavy metals. For example, the typical drilling rig on a gas well in north Louisiana and east Texas consumes approximately 800,000 gallons of fresh water and produces approximately the same amount of waste water.

Once the well-bore is drilled, the completion phase of the well begins. The completion phase involves setting pipe in the well bore, connecting the well bore to the hydrocarbon producing geological formations, and stimulating and/or fracturing the formations to facilitate the production of gas and/or oil. Each facet of completion requires fresh water as a lubricant, chemical delivery medium, and hydraulic fracture medium. The waste water from the completion phase is called flow-back, which consists of water mixed with various chemicals, suspended solids, and formation (geological) saltwater. Unlike reserve pit water, which can occasionally be returned to the fresh water cycle through surface disposal (where permitted), flow back water must be treated for reuse or disposed of via deep well injection due to the higher concentrations of salt, minerals, and chemical additives. Reuse requires storage and treatment of the flow-back, which poses logistical, economical, and environmental concerns. For example, a gas well in north Louisiana—east Texas uses approximately 500,000 gallons per completion and produces 20-80% of that amount of flow back water, depending on the specific completion technique and geological formation. Since each horizontal well may have 12 or more completion stages, an additional 6,000,000 gallons of water can be permanently withdrawn from the fresh water cycle.

After the well has been completed, the production phase begins. Most gas wells produce geological saltwater that naturally flows with the oil and gas as the well is producing. Early during the production stage, the water being co-produced with the gas resembles flow back and as the well reaches a steady production state, the water being produced is primarily geological saltwater. Typically, very little fresh water is consumed while a well is in production. Due to the high salt, mineral, and hydrocarbon content, the produced wastewater is almost always disposed of into an injection well. Thus, the production waste water did not originate from the freshwater cycle, and it is not introduced to the freshwater cycle. Some research groups and service companies are exploring the use of production water from an existing well as the source of saltwater for use during the completion phase of a new well. Utilizing geological saltwater as base fluid for exploration and production activities represents a gain on an operator's water balance sheet. The amount of produced waste water varies dramatically from well to well but typically ranges between 1,000 and 40,000 gallons per week. Treating production water for reuse requires removal of hydrocarbons, well-bore treatment chemicals, undesirable minerals, and in rare cases—desalination. Two hurdles to overcome in the course of reusing production wastewater are volume and transportation. Some geological formations make relatively large amounts of water and others very little production water. Storing, treating, and moving production water can pose a significant cost and logistical challenge.

Without costly and energy-intensive processing, most exploration and production waste water is not clean enough for release into the environment via land farming (surface discharge) and is therefore typically disposed of via deep well injection. In order to deep well inject the waste water, the fluids must be trucked or piped to a secondary location where the water is stored in tanks and pumped into a deep formation (below the lowest freshwater aquifer) where the water will never return to the freshwater cycle. Much of the cost for disposal of the waste water comes from hauling the water from the well site to the injection point. As shale gas plays continue to flourish around the United States, the industry's fresh water demands are continually increasing. Experts and regulatory agencies agree that a key factor in sustaining domestic on-shore oil and gas activity will be developing water conservation strategies for the industry. Several states have implemented regulations and incentives for exploration and production companies to reuse their waste water. In regions such as the Permian Basin and Eagleford Shale of west and south Texas, where exploration and production activities continue to increase, but water resources are already limited, and in densely populated areas where cities and exploration and production operators must share the water (such as the Barnett Shale in the Dallas-Fort Worth area), industry leaders have already begun to develop exploration and waste water reclamation processes. Currently, the public and private agencies developing these processes are focused primarily on adapting technologies and processes that are being effectively used to for waste water treatment in other industries, such as reverse osmosis (RO), evaporation/distillation, electro-coagulation (EC), chemical oxidation, chemical precipitation, serial filtration, and combinations thereof, but the systems developed to employ the technology lack portability, scalability, and versatility.

Since the waste streams in the oilfield change significantly and rapidly over short periods of time (in both volume and chemical composition), developers have struggled to design a single portable water treatment system that can handle the various waste streams.

### SUMMARY OF THE INVENTION

Applicant has recognized a need for a single portable and scalable water reclamation system that can handle various waste streams.

An embodiment of the water reclamation system of this invention includes at least one water filtration module mounted on a transport vehicle. The water filtration module comprises a bulk container and a plurality of treatment vessels positioned therein. Each treatment vessel has an upper fluid reservoir, a lower fluid reservoir, and a waste water treatment media positioned therebetween. A waste water distribution line is connected to and extends from a waste water inlet header into each of the treatment vessels for distributing waste water into the treatment vessels. A produced water line is connected to and extends from each of the treatment vessels and into a produced water collection header for collecting produced water from each of the treatment vessels. At least one waste water outlet line is connected to and extends from the bulk container and into a waste water outlet header for collecting waste water from the treatment vessels.

An embodiment of the water reclamation system of this invention includes a plurality of water filtration modules mounted on a transport vehicle. The plurality of water filtration modules each comprises a bulk container and a plurality of treatment vessels positioned therein. Each treatment vessel has an upper fluid reservoir, a lower fluid reservoir, and a waste water treatment media positioned therebetween. A waste water distribution manifold is connected to a waste water inlet header for controlling the distribution of waste water into each of the treatment vessels. A waste water distribution line is connected to and extends from the waste water distribution manifold into each of the treatment vessels for distributing waste water into the treatment vessels. A chemical treatment header is connected to a chemical treatment reservoir. A chemical treatment manifold is connected to the chemical treatment header for controlling the distribution of chemical treatment to each of the treatment vessels. A chemical treatment feed line is connected to and extends from the chemical treatment manifold and into the treatment vessels. A produced water line is connected to and extends from the treatment vessels and into a produced water collection header for collecting produced water from each of the treatment vessels. At least one waste water outlet line is connected to and extends from the bulk container and into a waste water outlet header for collecting waste water from the treatment vessels.

An embodiment of this invention is directed to a method of reclaiming waste water. The method comprises mounting at least one filtration module on a transport vehicle. The at least one filtration module has a bulk container, a plurality of treatment vessels positioned within the container, and is connected to a waste water inlet header, a produced water collection header, and a waste water outlet header. Each of the treatment vessels has a treatment media positioned therein. The transport vehicle is moved to a water reclamation site. Waste water is flowed into the waste water inlet header, thereby distributing the waste water into the treatment vessels. The waste water is engaged with the treatment media in the treatment vessels, thereby filtering the waste water. The produced water is collected from each of the treatment vessels in a produced water collection header. The waste water is collected from each of the treatment vessels in a waste water outlet header.

### BRIEF DESCRIPTION OF THE DRAWINGS

So that the mariner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic of a portable and scalable water reclamation system as comprised by an embodiment of the present invention.

FIG. 2 is a perspective view of a water reclamation system module.

FIG. 3 is an additional view of the water reclamation system module of FIG. 2.

FIG. 4 is an additional view of the water reclamation system module of FIG. 2.

FIG. 5 is view of a single treatment vessel.

FIG. 6 is schematic view of the treatment vessels connected to one another.

FIG. 7 is a schematic view of the treatment vessels connected to one another in an alternate embodiment.

FIG. 8 is a schematic view of the tea went vessels connected to one another in an additional alternate embodiment.

FIG. 9 is a schematic view of the treatment vessels connected to one another in an additional alternate embodiment.

FIG. 10 is a schematic view of the treatment vessels connected to one another in an additional alternate embodiment.

FIG. 11 is a perspective view of the portable and scalable water reclamation system connected to an over-the-road trailer.

FIG. 12 is a top plan schematic view of the portable and scalable water reclamation system connected to an over-the-road trailer.

FIG. 13 is a perspective view of a cat walk assembly as comprised by the present invention in an operational position.

FIG. 14 is an isolated and exploded view of the cat walk assembly.

FIG. 15 is an isolated view of the cat walk assembly as comprised by the present invention in the operational position, illustrating a support bar.

FIG. 16 is a view of the support bar in the extended position.

FIG. 17 is a view of the support bar in a retracted position.

FIG. 18 is a perspective view of the cat walk assembly as comprised by the present invention in an access position.

FIG. 19 is a perspective view of the cat walk assembly as comprised by the present invention in a transport position.

FIG. 20 is a schematic view of several reclamation system modules connected to one another in an embodiment of the present invention.

FIG. 21 is a schematic view of several reclamation system modules connected to one another in an alternate embodiment of the present invention.

FIG. 22 is a schematic view of several reclamation system modules connected to one another in an additional alternate embodiment.

FIG. 23 is a schematic view of several reclamation system modules connected to one another in an additional alternate embodiment.

FIG. 24 is a schematic view of several reclamation system modules connected to one another in an additional alternate embodiment.

FIG. 25 is a schematic view of several reclamation system modules connected to one another in an additional alternate embodiment.

FIG. 26 is a schematic view of several reclamation system modules connected to one another in an additional alternate embodiment.

FIG. 27 is a schematic view of several reclamation system modules connected to one another in an additional alternate embodiment.

FIG. 28 is a schematic view of several reclamation system modules connected to one another in an additional alternate embodiment.

### DETAILED DESCRIPTION OF THE INVENTION

The present invention now will be described more fully hereinafter with reference to the accompanying drawings in which a preferred embodiment of the invention is shown. This invention may, however, be embodied in many different foams and should not be construed as limited to the embodiment set forth herein; rather, this embodiment is provided so that this disclosure will be thorough and complete, and will fully convey the scope of the invention to those skilled in the art. Like numbers refer to like elements throughout.

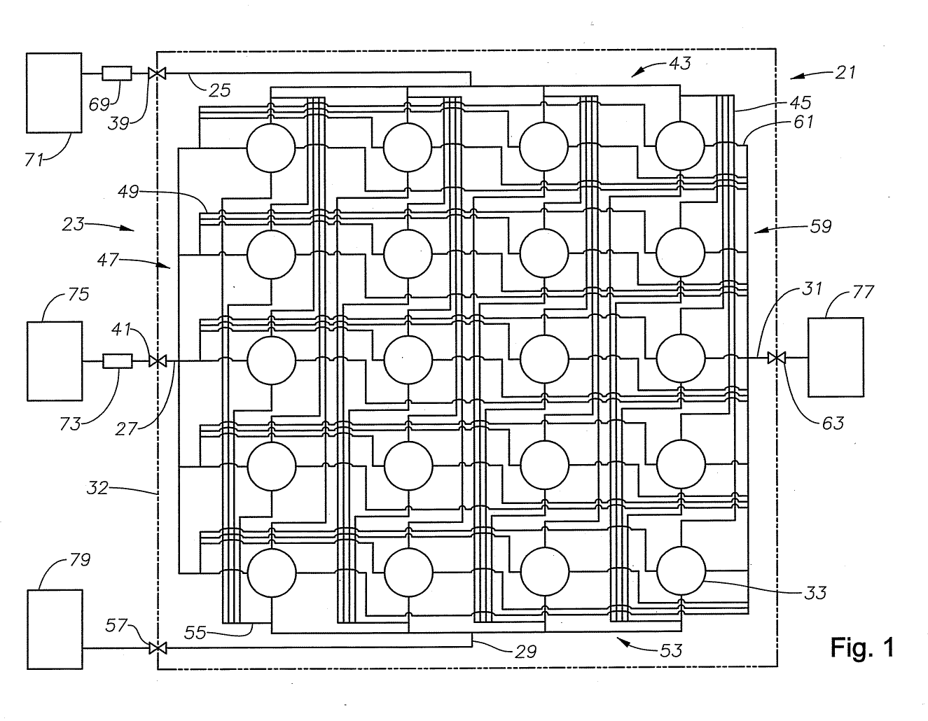

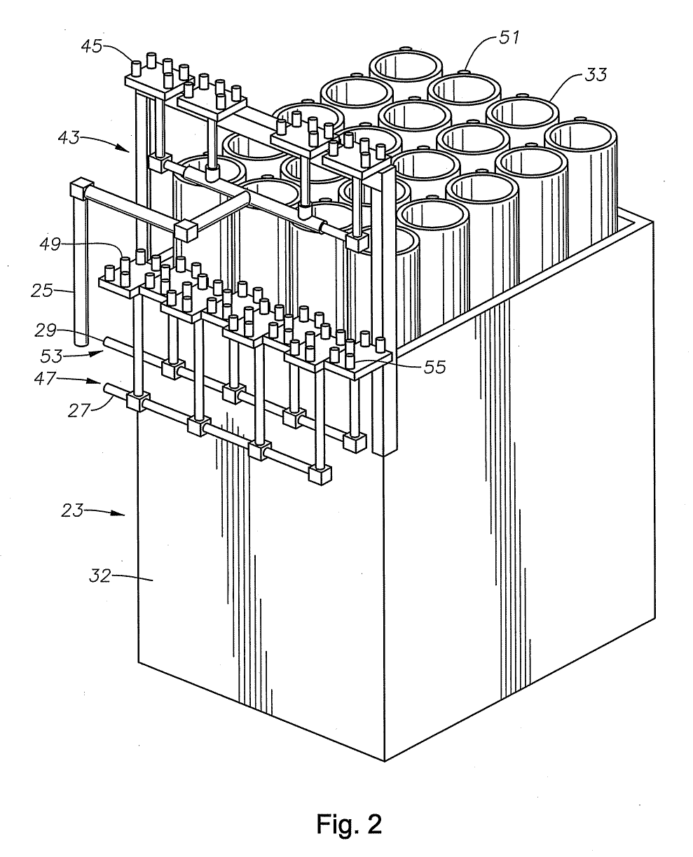

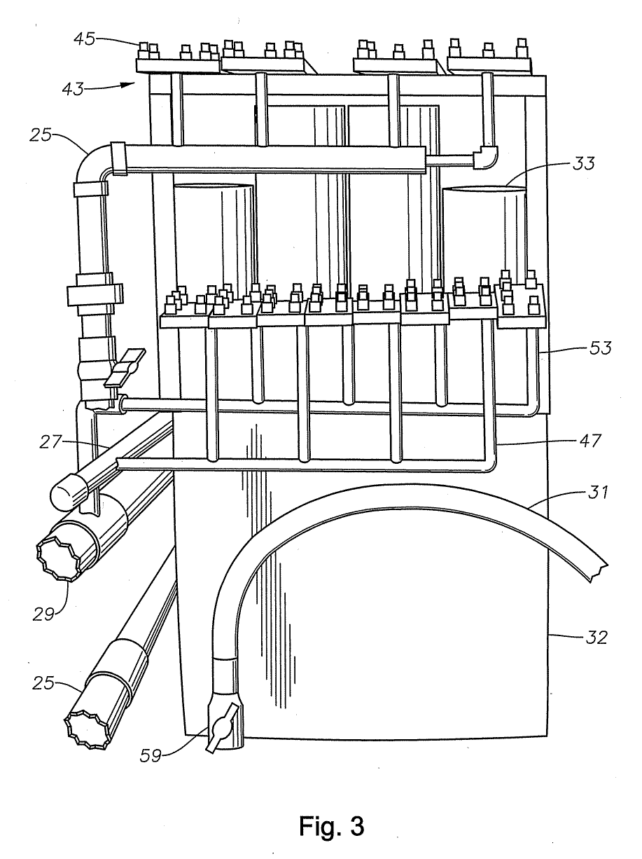

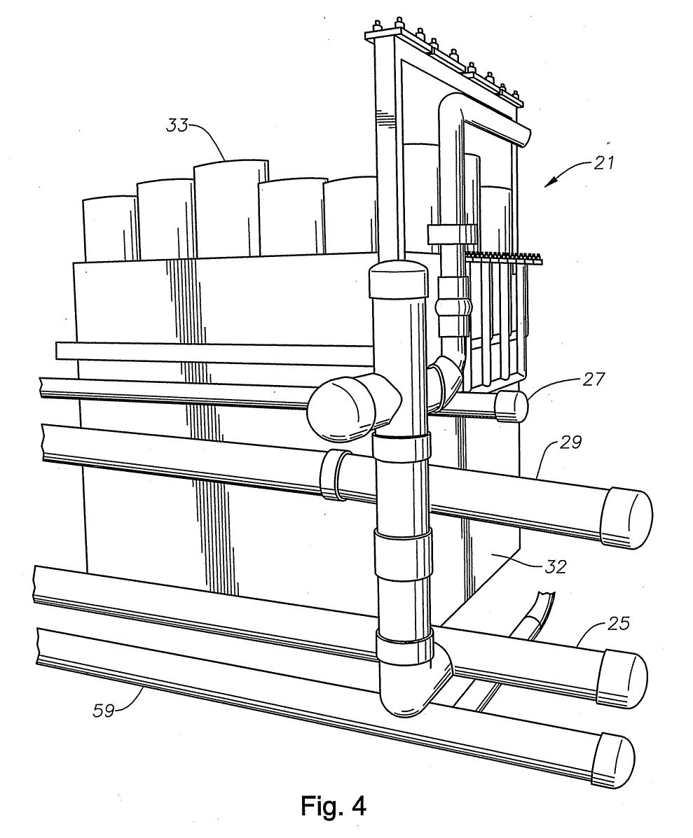

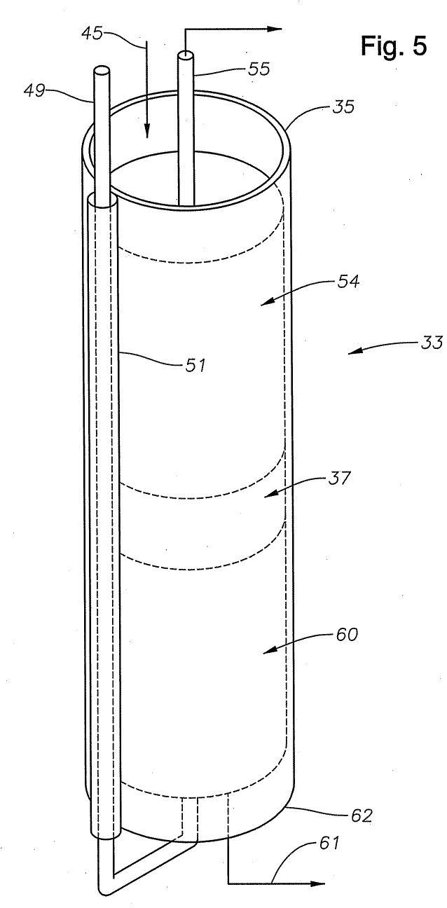

Referring to FIG. 1, an embodiment of a water reclamation system 21 comprises a water reclamation module 23 which is connected to a series of pools and/or tanks to thereby reclaim water. The water reclamation system 21 may use a number of different treatment methods, individually or in combination, including filtration (course, micro, ultra, or nano), flocculation/settling, chemical precipitation, affinity purification, ion-exchange, and other chemical treatment polishing processes. In this embodiment, the module 23 comprises a waste water inlet header 25, a chemical treatment header 27, a produced water collection header 29, and a waste water outlet header 31. In this embodiment, the module 23 further comprises a bulk container 32 and a plurality of treatment vessels 33 positioned within the bulk container 32. The bulk container 32 has a closed bottom end and an open top end, through which the tops of the treatment vessels 33 extend. In this embodiment, the module 23 comprises twenty individual treatment vessels 33. Each treatment vessel 33 houses a treatment media 37 (FIG. 5) and is appropriately shaped to allow multiple treatment vessels 33 to be nested together into the module 23. For example, in this embodiment, the treatment vessel 33 has a cylindrical body 35 (FIG. 5) with open ends and the treatment media 37 disposed therein. In alternate embodiments, the treatment vessels 33 may have various shaped bodies. The upstream connection from the waste water inlet header 25 is connected to the module 23 via a quick connect cam-lock coupling or union 39. The upstream connection from the chemical treatment header 27 is connected to the module 23 via a quick connect cam-lock coupling or union 41. The downstream connection from the waste water inlet header 25 is connected to a waste water distribution manifold 43 via a valve and union. In this embodiment, the waste water distribution manifold 43 is positioned at a height greater than the treatment vessels 33 to allow for gravity distribution of waste water (FIGS. 2 and 3). However, in alternate embodiments, waste water may be pumped through the waste water distribution manifold 43, thereby eliminating the need for gravity distribution and allowing the waste water distribution manifold 43 to be positioned at varying heights. A plurality of waste water distribution lines 45 extend from the waste water distribution manifold 43. Each waste water distribution line 45 extends from waste water distribution manifold 43 and into the corresponding treatment vessel 33. In this embodiment, each of the twenty individual waste water distribution lines 45 extend from the waste water distribution manifold 43 and into the corresponding treatment vessel 33 for each of the twenty individual treatment vessels 33.

The downstream connection from chemical treatment header 27 is connected to a chemical treatment manifold 47. A plurality of chemical treatment feed lines 49 extend from the chemical treatment manifold 47. Each chemical treatment feed line 49 extends from the chemical treatment manifold 47 into a chemical treatment feed line chase 51 (FIG. 5) located on a corresponding treatment vessel 33. In this embodiment, each of the twenty individual chemical treatment feed lines 49 extend from the chemical treatment manifold 47 and into the corresponding chase 51 of the corresponding treatment vessel 33 for each of the twenty individual treatment vessels 33.

The upstream connection from the produced water collection header 29 is connected to a produced water collection manifold 53. The upstream connection from the produced water collection manifold 53 is connected to a plurality of produced water lines 55. In this embodiment, each produced water line 55 extends from the downstream (treated) outlet of the treatment media 54 of each corresponding treatment vessel 33 to the produced water collection manifold 53 (FIG. 5). In this embodiment, a produced water line 55 extends from the treatment vessel 33 to the produced water collection manifold 53 for each of the twenty individual treatment vessels 33. The downstream connection from the produced water collection manifold 53 feeds into the produced water collection header 29 via a valve and union. The downstream connection from the produced water collection header 29 is connected to the module 23 via a quick connect cam-lock coupling or union 57.

The upstream connection from the waste water outlet header 31 is connected to a waste water collection manifold 59 via a valve and union. The upstream connection from the waste water collection manifold 59 is connected to either a singular and common or multiple waste water outlet lines 61. Each waste water outlet line 61 collects the unreclaimed waste water into the waste water collection manifold 59 via the lower portion 62 of a corresponding treatment vessel 33 (FIG. 5). In this embodiment, a single waste water collection line 61 collects the waste water for the twenty individual treatment vessels 33 from the bottom of the bulk container 32. The downstream connection from waste water outlet header 31 is connected to the module 23 via a quick connect cam-lock coupling or union 63.

Referring to FIG. 5, in this embodiment, each treatment vessel 33 comprises an open upper fluid reservoir 54, an open lower fluid reservoir 60, and a treatment media 37 located therebetween. The treatment media 37 contained within the treatment vessels 33 depend on the desired reclamation process. The chemical treatment line chase 51 is connected to the body of each treatment vessel 33 and extends axially along the treatment vessel housing, running parallel to the treatment vessel 33 before entering the lower fluid reservoir 60. As previously discussed, in this embodiment of the present invention, the chemical treatment feed line 49 passes through the chemical treatment chase 51. Waste water is fed into the upper fluid reservoir 54 of each treatment vessel 33 through the corresponding waste water distribution line 45. In this embodiment, the unreclaimed waste water exits each treatment vessel 33 through an opening in the lower fluid reservoir 60, where it is collected by the single waste collection line 61 which is connected to the bulk container 32. In alternate embodiments, the unreclaimed waste can be collected through individual waste collections lines 61 connected to each treatment vessel 33 and to the waste collection manifold 59. The reclaimed/produced water exits each treatment vessel 33 through the corresponding produced water feed line 55.

Referring back to FIG. 1, in this embodiment, a motor and pump assembly 69 are connected upstream of the waste water header 25. A waste water source or reservoir 71 is located upstream of the motor and pump assembly 69. For example, the waste water source 71 may be a pool of low total dissolved solute (TDS) water from oilfield drilling and/or completion waste. The motor and pump assembly 69, when activated, will draw the waste water from the waste water source 71 and pump it into the waste water header 25 and the waste water distribution manifold 43.

In this embodiment, a second motor and pump assembly 73 are connected upstream of the chemical treatment header 27. A chemical treatment tank or reservoir 75 is located upstream of the motor and pump assembly 73. For example, the chemical treatment tank 75 may be a tank of sodium chloride or another chemical necessary for chemical treatment of the waste water including, but not limited to pH adjusting chemicals, flocculants, polymers, resin activators, emulsifiers, de-emulsifies, detergents, solvents, catalysts, and/or specialized reactants. The motor and pump assembly 73, when activated, will draw the contents of the chemical treatment tank 75 from the tank 75 and into the chemical treatment header 27 and the chemical treatment manifold 47. The motor and pump assemblies 69, 73 are powered by a power source, for example, a generator.

In operation, the waste water inlet header 25 is connected to the waste water source 71 via the quick connect cam-lock coupling or union 39. The chemical treatment header 27 is connected to the chemical treatment tank 75 via the quick connect cam-lock coupling or union 41. The waste water outlet header 31 is connected to a waste water tank 77 via the quick connect cam-lock coupling or union 63. In this embodiment, the waste water is continuously recirculated through the water reclamation system 21 until the desired amount of waste water is reclaimed. In alternate embodiments, the waste water may pass through the reclamation system once 21 and be subsequently stored in a waste water tank for disposal. The motor and pump assemblies 69, 73 are activated. Waste water is drawn from the waste water source 71 via the pump and motor assembly 69, pumped through the waste water inlet header 25, and into the waste water distribution manifold 43. In this embodiment, chemical treatment of the waste water is desired. As a result, chemical solution, for example, concentrated sodium chloride, is drawn from the chemical treatment source 75 via the pump and motor assembly 73, pumped through the chemical treatment header 27, and into the chemical treatment manifold 47.

In this embodiment, when the waste water reaches the upper reservoir 54 of each treatment vessel 33 (via the waste water distribution manifold 43 and water distribution lines 45), gravity feeds the waste water through the treatment media 37 (FIG. 5). In an alternate embodiment, the waste water may not merely be gravity fed, for example, an additional pump may be connected to draw the waste water through the treatment media 37. The treatment media 37 positioned between the upper 54 and lower 60 fluid reservoirs of each treatment vessel 33 creates a semi-permeable or selectively permeable barrier separating the two reservoirs 54, 60. When the chemical solution reaches the chemical treatment manifold 47, gravity and the difference in hydrostatic pressure feeds the chemical solution through the manifold 47 and into each of the chemical treatment feed lines 49. In an alternate embodiment, the chemical solution may not merely be gravity fed, for example, an additional pump may be connected to feed the chemical solution into each of the chemical treatment feed lines 49. The chemical solution flows through each of the chemical treatment feed lines 49 and, in this embodiment, into the lower reservoir 60 of each treatment vessel 33 via the corresponding chemical treatment chase 51.

In this particular embodiment, pressure differences on each side of the treatment media 37 and the differences in hydrostatic pressure between the upper 54 and lower 60 reservoirs causes the waste water to be pulled through the treatment media 37 in each treatment vessel 33, where it becomes produced (i.e., reclaimed) water. In alternate embodiments, hydrostatic pressure, capillary action, differential surface tension, and/or selectively permeability may result in transition of waste water to reclaimed water, depending on the treatment media and the chemical additives. In this embodiment, the produced water is pushed through the produced water lines 55 connected to each of the treatment vessels 33 via gravitational forces on the fluid in the reservoirs 54, 60. In an alternate embodiment, the produced water may not merely be gravity fed, for example, a pump may be connected to draw the produced water through the produced water lines 55. The produced water travels through the produced water lines 55, into the produced water collection manifold 53, and into the produced water collection header 29. The produced water then travels through the produced water collection header 29, through the quick cam-lock coupling or union 57, and into a produced water collection tank 79.

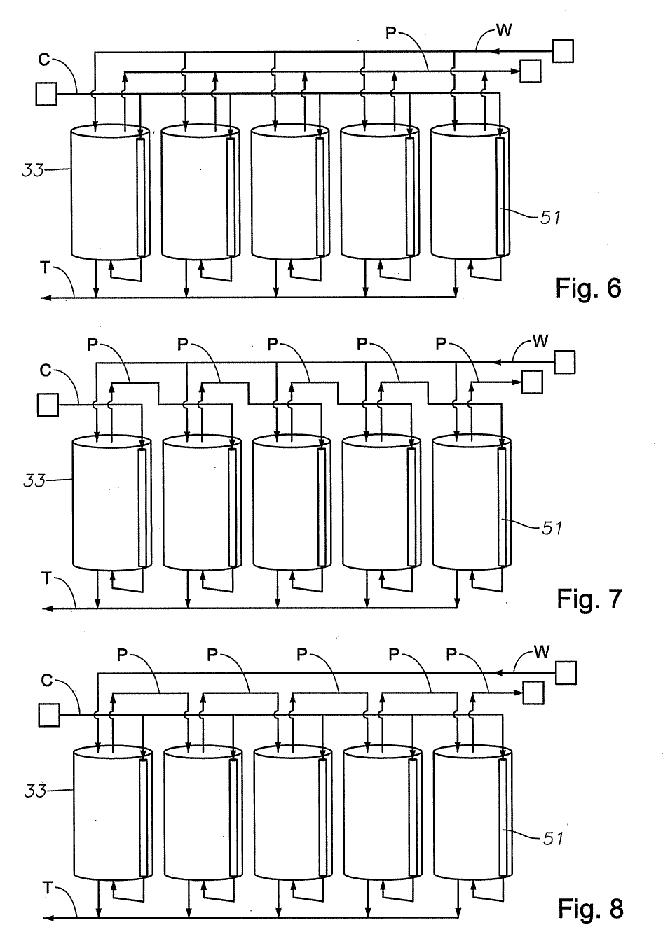

The waste water that was not reclaimed passes through an opening in the lower reservoir 60 of each of the treatment vessels 33, where it enters the waste water outlet line 61. The waste water then drains into the waste water outlet manifold 59, and into the waste water outlet header 31. The waste water continues through the waste water outlet header 31, through the quick cam-lock coupling or union 63, and into a waste water tank 81. As previously indicated, the waste water may be recirculated through the reclamation system 21 until the desired results are achieved. FIG. 6 illustrates the way in which the chemical solution C, waste water W, treated waste water T, and the produced water P flow through a series of treatment vessels 33 as set up in this embodiment of the reclamation system 21.

In an alternate embodiment, the module 23 may further comprise an overflow/volume control header. The overflow/volume control header would either be connected to an overflow/volume control manifold or directly to overflow/volume control lines. The overflow/volume control lines would be connected to an overflow/volume control port or ports in an upper surface portion of the bulk container 32. In the event that the fluid level in the bulk container 32 reached the port or ports, the excess fluid would travel through the overflow/volume control lines and the overflow/volume control manifold and/or header. The excess fluid could be captured for future reclamation or could be re-circulated back into the current reclamation cycle.

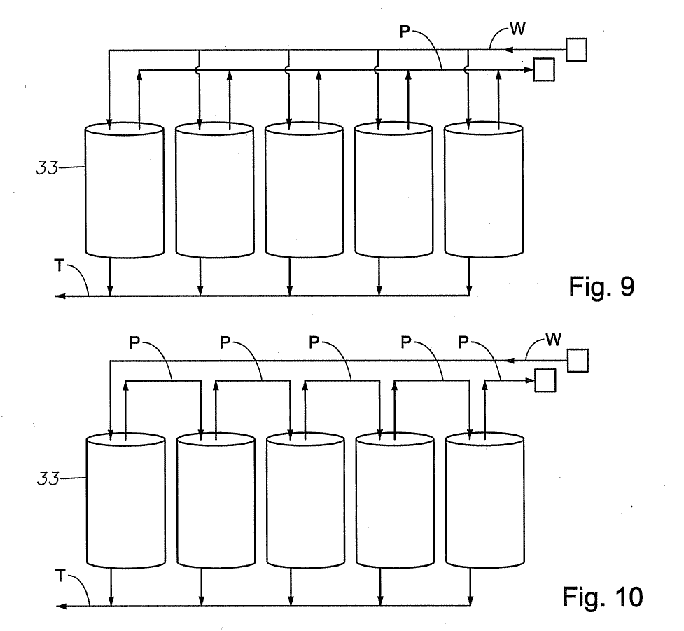

Depending upon the desired method of filtration and the desired level of treatment, each of the treatment vessels 33 in a treatment module 23 can be connected in various ways to facilitate a particular reclamation process. For example, as illustrated in FIG. 7, in an alternate embodiment, the treatment vessels 33 are arranged such that the produced water P out from a first treatment vessel is then added to the treatment chase 51 of each treatment vessel thereafter, which may contain the same or different treatment media. In an additional alternate embodiment as illustrated in FIG. 8, waste water W is introduced into a first treatment vessel 33, and the produced water P is then run through each of the treatment vessels 33 thereafter. In an additional alternate embodiment as illustrated in FIG. 9, no chemical treatment is applied to the treatment vessels 33, and waste water W is fed into each treatment vessel 33, and produced water P is extracted from each treatment vessel 33. In an additional alternate embodiment as illustrated in FIG. 10, no chemical treatment is applied to the treatment vessels 33, and waste water W is only fed into the first treatment vessel. The produced water is then fed from the first treatment vessel into the second treatment vessel, and so forth thereafter.

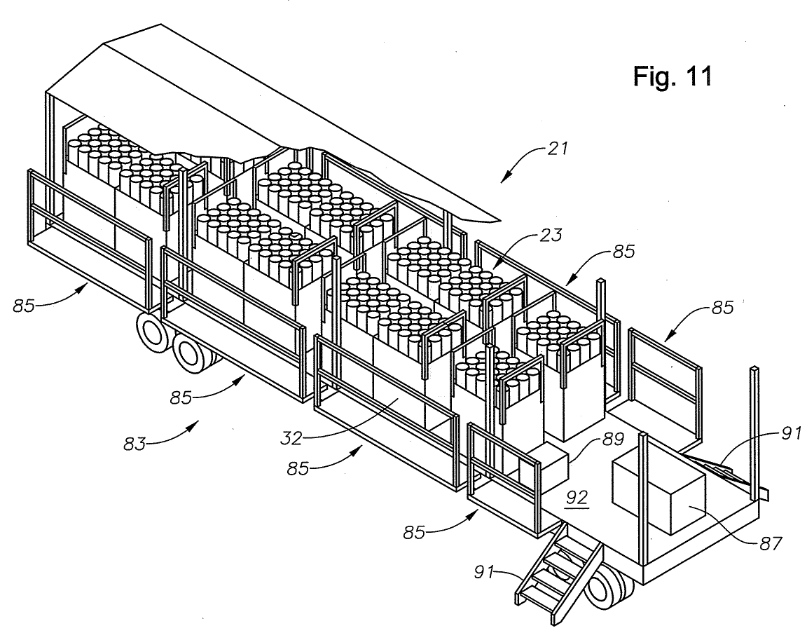

The water reclamation system 21 as comprised by the present invention is both scalable and portable. Referring to FIG. 11, a plurality of modules 23, in this embodiment, fourteen modules 23 are connected to a trailer 83. The trailer 83 may be an over-the-road flat-bed style trailer, which allows the water reclamation system 21 to be transported and maneuvered for various applications; for example, reclamation of waste water in decentralized and/or short term industries such as oil and gas and environmental remediation. In this embodiment, the modules 23 are positioned on the trailer 83 to provide access to the modules 23 and the corresponding pipes and headers extending therebetween.

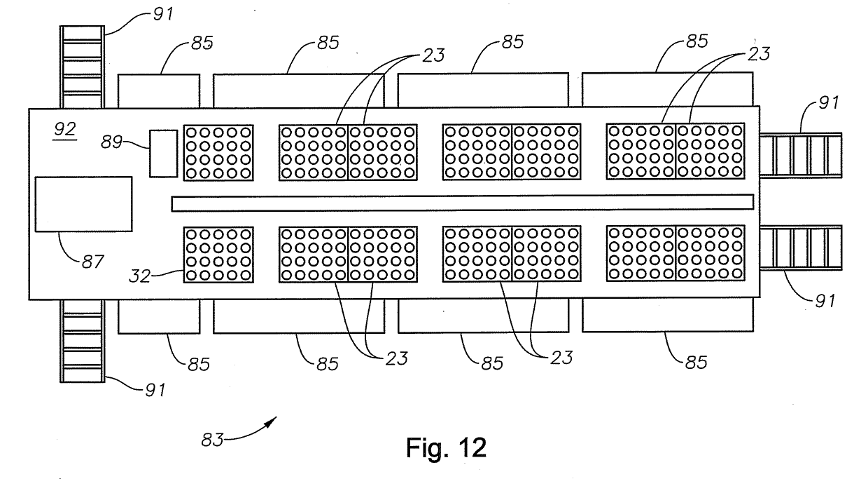

Referring to FIG. 12, in this embodiment, the trailer 83 has a plurality of cat walk assemblies 85 positioned around the perimeter of the trailer 83. The trailer also comprises a power source 87, for example, a generator. In this embodiment, a pump and motor assembly 89 are positioned on the trailer 83. The pump and motor assembly 89 may be either of the pump and motor assemblies 69, 73 as previously discussed, or may be an alternative or additional pump and motor assembly. A plurality of retractable or fold-up ladders 91 are connected to the trailer 83 and provide access to the trailer deck 92 and the various components of the trailer 83. The trailer 83 may additionally comprise hose racks, pump racks, and lights that may be used during the transport and operation of the reclamation system 21. In this embodiment, the trailer 83 is covered by a roof structure 93 (FIG. 11), while the sides are retractable or removable. For example, in this embodiment, the sides of the trailer 83 are curtained. The trailer 83 comprises a self-sustained and self-contained portable water reclamation system 21.

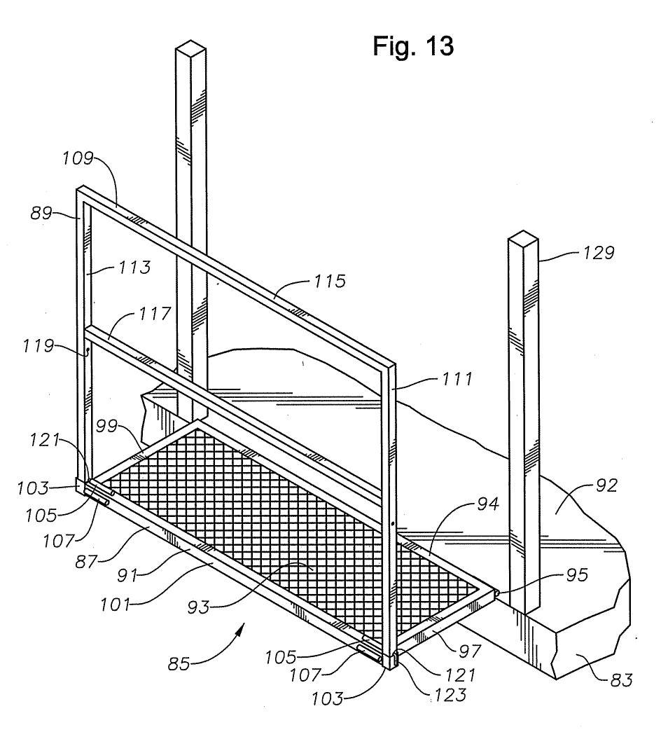

Referring to FIG. 13, in this embodiment, each cat walk assembly 85 comprises a cat walk 87 and a hand rail 89 connected to one another. In this embodiment, the cat walk 87 comprises a rectangular frame 91 with expanded metal 93 connected to and extending between the frame 91. In this embodiment, the frame 91 is comprised of rectangular members, but may be shaped differently in alternate embodiments. A first leg 94 of the frame 91 extends longitudinally along a length of the trailer 83 and is rotatably connected to the trailer 83 by a plurality of hinges or similar devices 95, thereby enabling the cat walk 87 to rotate relative to the trailer 83 about an axis extending parallel to and with the first leg 94. The second 97 and third 99 legs of the frame 91 are positioned substantially perpendicular to the first leg 94, but are parallel to one another, and extend outwardly from opposite ends of the first leg 94 before connecting to the fourth leg 101 of the frame 91, which is substantially parallel to the first leg 94. Depending upon the size of the cat walk 87, the frame 91 may have additional support members that extend between the first 94 and second 97 legs.

Sleeves 103 are rotatably connected to an outer surface portion of the second 97 and third 99 legs of the frame 91, near the ends of the legs 97, 99 that are connected to the fourth leg 101. The sleeves 103 are capable of rotation about an axis parallel to the axis of the fourth leg 101. In this embodiment, the sleeves 103 are rectangular in shape. First cylindrical sleeves 105 are connected to upper surface portions of the fourth leg 101 near the ends of the leg 101 connected to the second 97 and third 99 legs. The cylindrical sleeves 105 extend axially along a length of the fourth leg 101 parallel to the axis of the fourth leg 101. Second cylindrical sleeves 107 are connected to outer surface portions of the fourth leg 101 near the ends of the leg 101 connected to the second 97 and third 99 legs. The cylindrical sleeves 107 extend axially along a length of the fourth leg 101, parallel to the axis of the fourth leg 101.

In this embodiment, the hand rail 89 is comprised of a substantially rectangular frame 109. In this embodiment, the frame 109 is comprised of rectangular members, but may be shaped differently in alternate embodiments. The frame 109 comprises first 111 and second 113 legs positioned spaced apart from and parallel to one another, each having first and second ends. A third leg 115 is connected to and extends between the first ends of the first 111 and second legs 113, substantially perpendicular to the first 111 and second 113 legs. A fourth leg 117 is connected to and extends between the first 111 and second 113 legs, substantially perpendicular to the first 11 and second 113 legs, a select distance from and parallel to the third leg 115. A first hole or aperture 119 is located in and extends through a medial portion of the first 111 and second legs 113, parallel to the third 115 and fourth 117 legs. A second hole or aperture 121 is located in and extends through the second end portion of the first 111 and second legs 113, a select distance from the first holes 119, and parallel to the third 115 and fourth 117 legs.

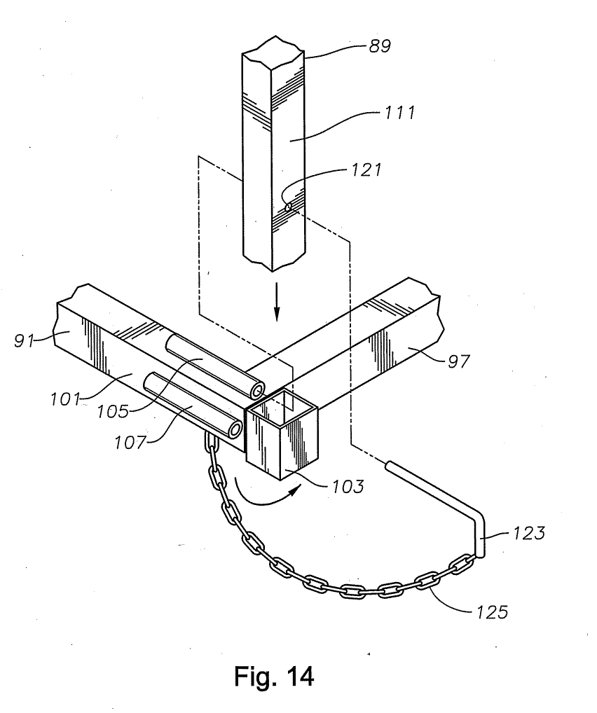

The second ends of the first 111 and second 113 legs of the hand rail 89 are positioned within the sleeves 103, which are rotatably connected to the cat walk 97. In the position illustrated in FIG. 13, the operational position, the sleeves 103 and first 111 and second 113 legs of the hand rail 89 are positioned substantially perpendicular to the second 97 and third 99 legs of the catwalk frame 91. In the operational position, the catwalk 87 is positioned substantially parallel with the trailer deck 92. Referring to FIG. 14, a generally L-shaped pin 123 extends through each of the second holes 121 in the hand rail 89 before being inserted into the first cylindrical sleeves 105 on the upper surface portions of the fourth leg 101 of the cat walk 87. The pins 123 lock the hand rail 89 in an operation position relative to the cat walk 87. A chain 125 is connected to he pin 123 on one end and the cat walk frame 91 on the other to prevent the loss of the pin 123 when it is not engaged. The pins 123 and sleeves 103 act as a locking device.

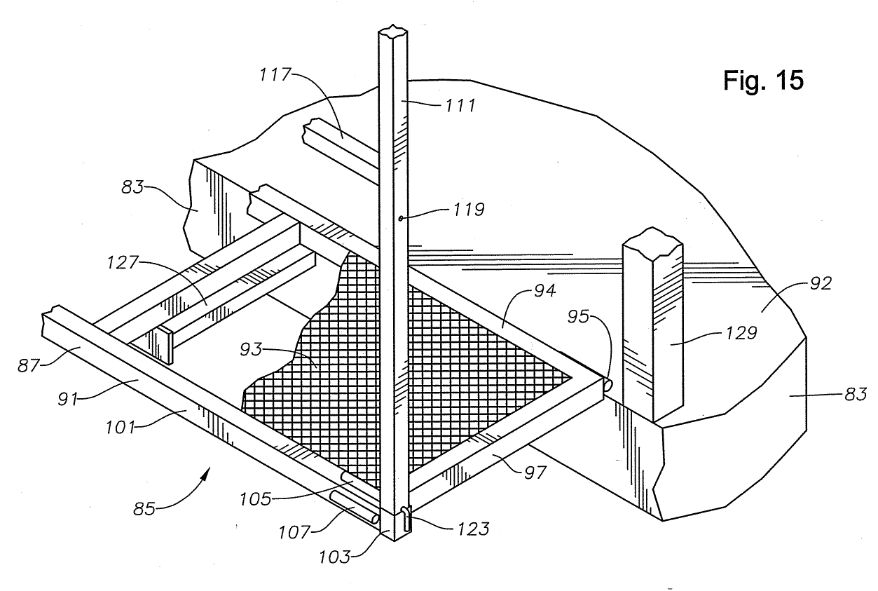

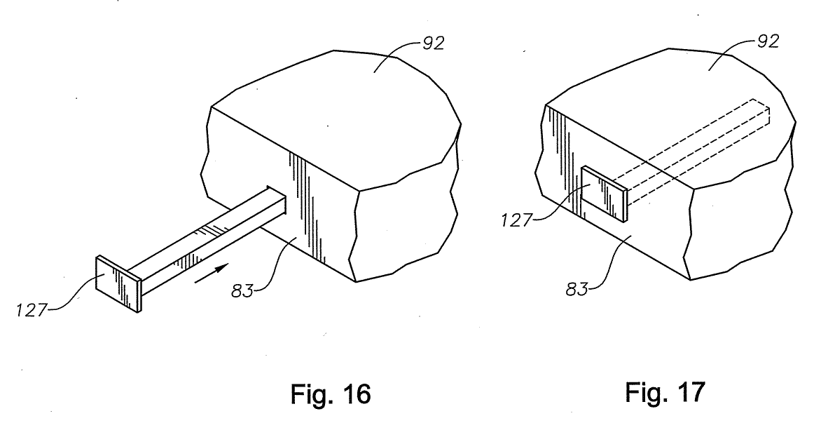

As illustrated in FIGS. 15, 16, and 17, a plurality of cantilever like support beams or bars 127 are retractably connected to the trailer 83. In this embodiment, the support bars 127 are rectangular members designed to extend outwardly from the trailer 83 when needed. In the operational position, the support bars 127 are parallel with the cat walk 87 and have flange portions abuttingly contacting portions of the cat walk frame 91. The support bars 127 act to support and maintain the cat walk 87 in its operational position. As illustrated in FIGS. 16 and 17, when the support bars on not needed, i.e., the cat walk 87 is not in the operational position, the support bars 127 slidingly retract into the trailer 83. When the support bars 127 are needed, they may be slidingly extended outwardly from the trailer 83.

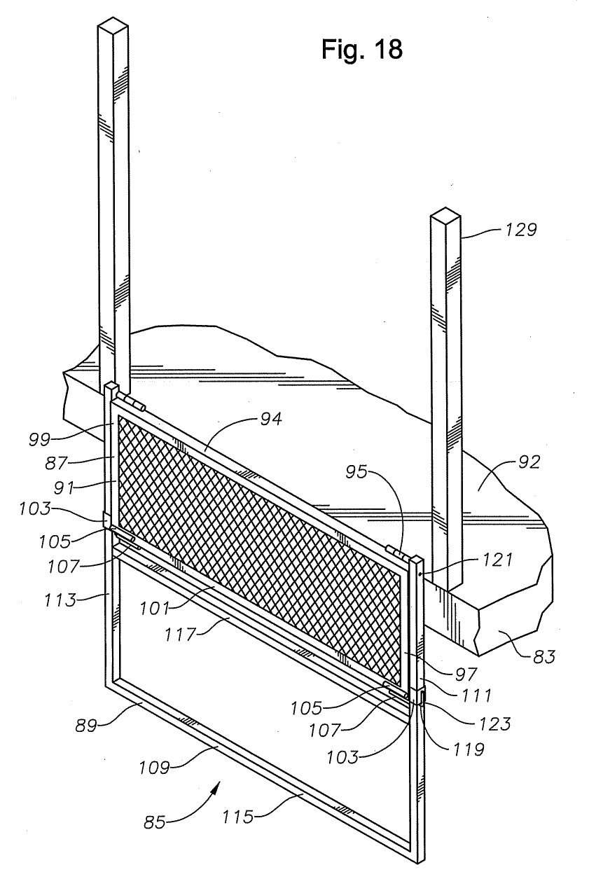

Referring to FIG. 18, the cat walk assembly 85 can be moved to an access position that allows access to the side of the trailer 83 to service the system 21. For example, if one of the modules 23 needs to be removed from the trailer deck 92, the cat walk assembly 85 will be moved to the access position to permit access to the module 23. Referring back to FIG. 13, to move the cat walk assembly 85 from an operational position to an access position (FIG. 18), the L-shaped pins 123 are removed from each of the second holes 121 in the hand rail 89 and the first cylindrical sleeves 105 on the upper surface portions of the fourth leg 101 of the cat walk frame 91. The sleeves 103, and thus, the hand rail 89 may freely rotate relative to the cat walk 87 and the first 111 and second 113 legs of the hand rail 89 may move axially within the sleeves 103. The support bars 127 are slidingly retracted into the trailer 83, thereby permitting the cat walk 91 to rotate downward relative to the trailer 83. The cat walk 87 is rotated downward relative to the trailer deck 92 toward the access position. The first 111 and second 113 legs of the hand rail 89 are extended further through the sleeves 103, until the first holes 119 are aligned with the second cylindrical sleeves 107. In the position illustrated in FIG. 18, the access position, the sleeves 103 and first 111 and second 113 legs of the hand rail are positioned parallel to the second 97 and third 99 legs of the catwalk frame 91. The L-shaped pins 123 extend through each of the first holes 119 in the hand rail 89 before being inserted into the second cylindrical sleeves 107 on the outer surface portions of the fourth leg 101 of the cat walk frame 91. The pins 123 lock the hand rail 89 in an access position relative to the cat walk 87. The cat walk assembly assembly 85 as illustrated in FIG. 18 is in an access position. The pins 123 and sleeves 107 act as a locking device.

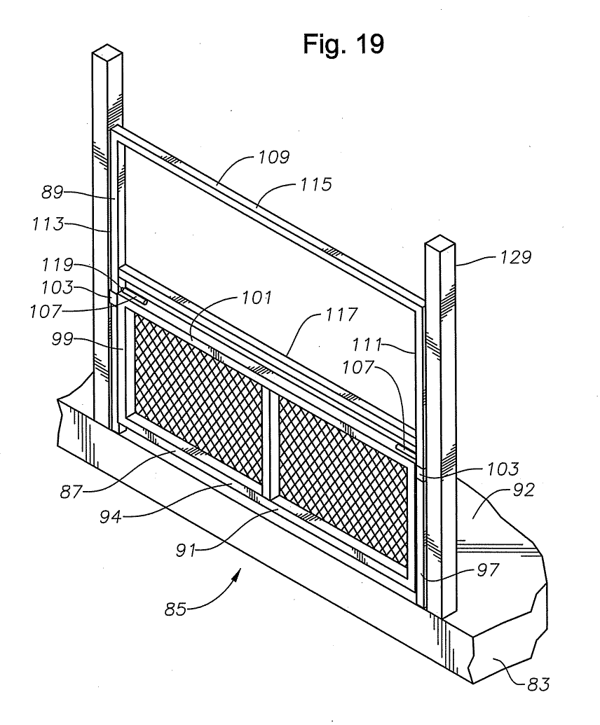

Referring to FIG. 19, the cat walk assembly 85 can be moved to a travel or transport position for transportation or movement of the trailer 83. While the cat walk assembly 85 can be moved from the operational position (FIG. 13) to the transport position (FIG. 19), for simplification purposes, the following illustration will move the cat walk assembly 85 from the access position (FIG. 18) to the transport position. Referring back to FIG. 18, to move the cat walk assembly 85 from an access position, the cat walk 87 is rotated upward relative to the trailer deck 92 toward the transport position. In the position illustrated in FIG. 19, the transport position, the sleeves 103 and the first 111 and second 113 legs of the hand rail are positioned parallel to the second 97 and third 99 legs of the catwalk frame 91. The L-shaped pins 123 extend through each of the first holes 119 in the hand rail 89 before being inserted into the second cylindrical sleeves 107 on the outer surface portions of the fourth leg 101 of the cat walk frame 91. The pins 123 lock the hand rail 89 in a transport position relative to the cat walk 87. The cat walk assembly 85 as illustrated in FIG. 19 is in a transport position. The cat walk assembly 85 in the transport position can be securely connected to the trailer 85 for transport. For example, the cat walk assembly 85 may be connected to a roof support member 129 by a fastener or other similar device.

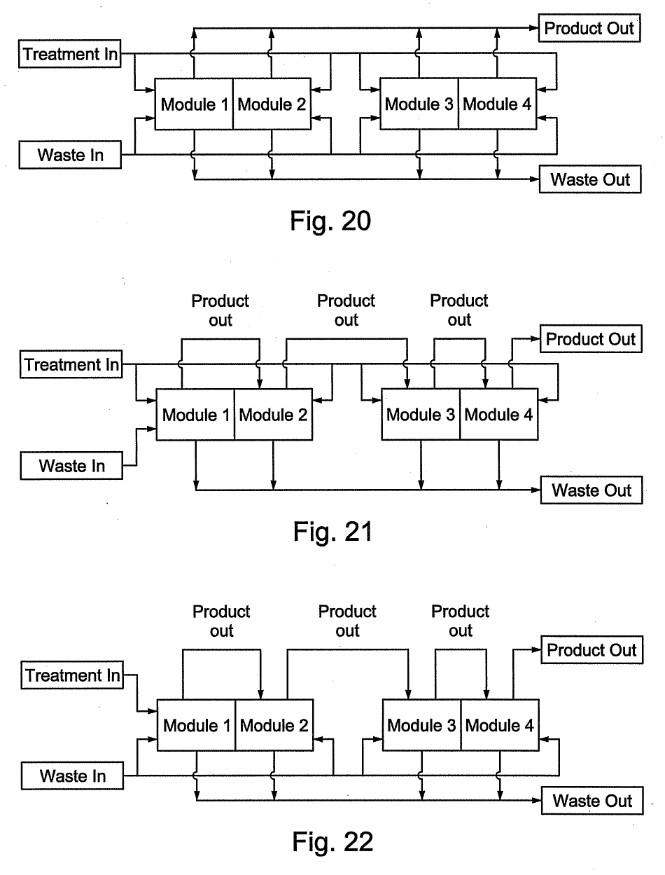

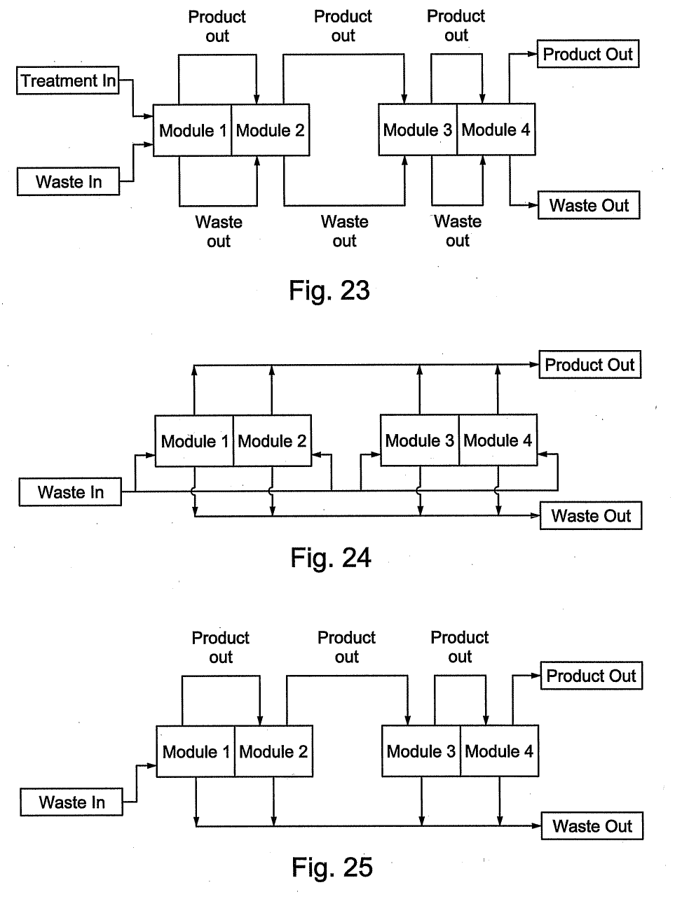

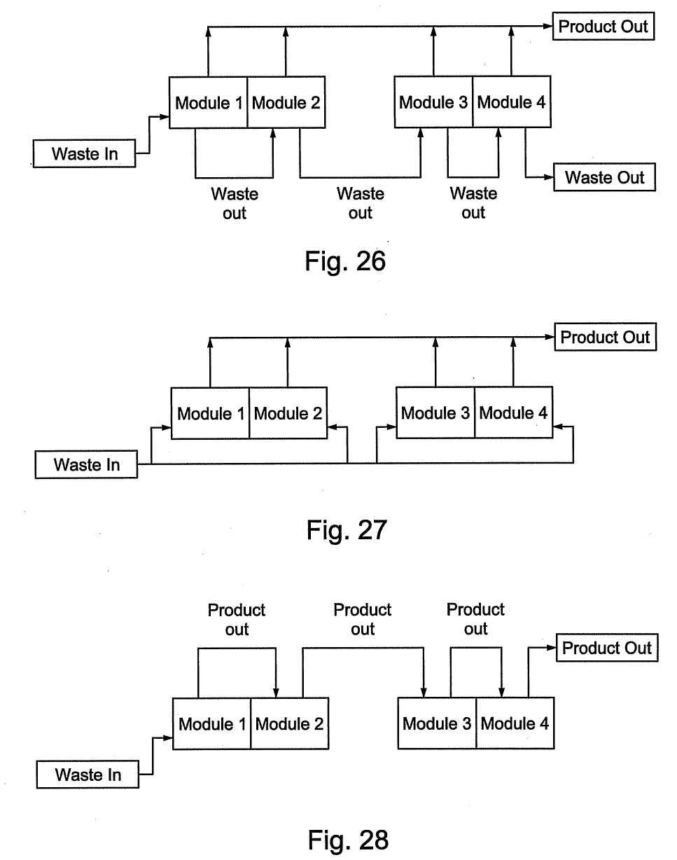

As the individual treatment vessels in a module may be connected in various ways to achieve a desired treatment method and result, the modules in a multi-module system, similar to that illustrated in FIGS. 11 and 12, may be connected in various ways to also achieve desired treatment methods and results. For example, in alternate embodiments as illustrated in FIGS. 20 through 28, the modules in a multi-module system may be connected to one another in various ways to achieve desired treatment methods and results.

The invention has significant advantages. The portable and scalable water filtration system uses low pressure (primarily gravity) and differences in hydrostatic head height to control the flow rates through the system. The system can be scaled up and down for various reclamation projects. The water reclamation system has various applications for oil and gas exploration and production, environmental remediation, industrial hygiene, agriculture, and other wastewater producing decentralized or centralized industries.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as set forth in the following claims.

1. An apparatus for reclaiming waste water, the apparatus comprising:
a transport vehicle;
at least one water filtration module mounted on the vehicle for reclaiming a quantity of waste water, the water filtration module comprising a bulk container and a plurality of treatment vessels positioned therein, each treatment vessel having an upper fluid reservoir, a lower fluid reservoir, and a waste water treatment media positioned therebetween;
a waste water inlet header;
a waste water distribution line connected to and extending from the waster water inlet header into each of the plurality of treatment vessels for distributing waste water into the plurality of treatment vessels;
a produced water collection header;
a produced water line connected to and extending from each of the plurality of treatment vessels and into the produced water collection header for collecting produced water from each of the plurality of treatment vessels;
a waste water outlet header; and
at least one waste water outlet line connected to and extending from the bulk container and into the waste water outlet header for collecting waste water from the plurality of treatment vessels.

2. The apparatus as defined in claim 1, further comprising:
a chemical treatment reservoir;
a chemical treatment header connected to the chemical treatment reservoir; and
a chemical treatment feed line connected to and extending from the each of the plurality of treatment vessels and into the chemical treatment header for distributing chemical treatment from the chemical treatment reservoir and into the plurality of treatment vessels.

3. The apparatus as defined in claim 2, further comprising:
a chemical treatment distribution manifold connected to the chemical treatment header and each chemical treatment feed line for controlling the distribution of chemical treatment to each of the plurality of treatment vessels.

4. The apparatus as defined in claim 1, further comprising:
a volume control port positioned in and extending through an outer surface portion of the bulk container;
a volume control header; and
a volume control line connected to and extending from the volume control port and into the volume control header for collecting fluid from the bulk container when the fluid level inside the bulk container reaches the volume control port.

5. The apparatus as defined in claim 1, further comprising:
at least one cat walk assembly connected to an outer perimeter portion of the transport vehicle, the cat walk assembly being selectively movable between a transport position, an operational position, and an access position, the at least one cat walk assembly comprising:
at least one support bar retractably extending outwardly from the transport vehicle;
a rectangular cat walk rotatably connected along one of its sides to the transport vehicle, a lower surface portion of the cat walk abuttingly contacting the at least one support bar;
a hand rail rotatably connected to the cat walk opposite the side of the cat walk connected to the transport vehicle, the hand rail capable of rotational and axial movement relative to the cat walk; and
a locking device for restricting the rotational and axial movement of the hand rail relative to the cat walk when in a locked position.

6. The apparatus as defined in claim 1, further comprising:
at least one pump mounted on the transport vehicle for pumping fluid through the at least one water filtration module.

7. The apparatus as defined in claim 1, further comprising:
a waste water distribution manifold connected to the waste water inlet header and each waste water distribution line for controlling the distribution of waste water to each of the plurality of treatment vessels; and
a produced water collection manifold connected to the produced water collection header and each produced water line for controlling the collection of produced water from each of the plurality of treatment vessels.

8. An apparatus for reclaiming waste water, the apparatus comprising:
a transport vehicle;
a plurality of water filtration modules mounted on the vehicle for reclaiming a quantity of waste water, the plurality of water filtration modules each comprising a bulk container and a plurality of treatment vessels positioned therein, each treatment vessel having an upper fluid reservoir, a lower fluid reservoir, and a waste water treatment media positioned therebetween;
a waste water inlet header;
a waste water distribution manifold connected to the waste water inlet header for controlling the distribution of waste water to each of the plurality of treatment vessels;
a waste water distribution line connected to and extending from the waste water distribution manifold into each of the plurality of treatment vessels for distributing waste water into each of the plurality of treatment vessels;
a chemical treatment reservoir;
a chemical treatment header connected to the chemical treatment reservoir;
a chemical treatment manifold connected to the chemical treatment header for controlling the distribution of chemical treatment to each of the plurality of treatment vessels;
a chemical treatment feed line connected to and extending from the each of the plurality of treatment vessels and into the chemical treatment manifold;
a produced water collection header;
a produced water line connected to and extending from each of the plurality of treatment vessels and into the produced water collection header for collecting produced water from each of the plurality of treatment vessels; and
at least one waste water outlet line connected to and extending from the bulk container and into the waste water outlet header for collecting waste water from the plurality of treatment vessels.

9. The apparatus as defined in claim 8, further comprising:
a waste water distribution manifold connected to the waste water header and each waste water distribution line for controlling the distribution of waste water to each of the plurality of treatment vessels; and
a produced water collection manifold connected to the produced water collection header and each produced water line for controlling the collection of produced water from each of the plurality of treatment vessels.

10. The apparatus as defined in claim 8, further comprising:
at least one pump mounted on the transport vehicle for pumping fluid through plurality of filtration modules.

11. The apparatus as defined in claim 8, further comprising:
at least one cat walk assembly connected to an outer perimeter portion of the transport vehicle, the cat walk assembly being selectively movable between a transport position, an operational position, and an access position, the at least one cat walk assembly comprising:
at least one support bar retractably extending outwardly from the transport vehicle;
a rectangular cat walk rotatably connected along one of its sides to the transport vehicle, a lower surface portion of the cat walk abuttingly contacting the at least one support bar;
a hand rail rotatably connected to the cat walk opposite the side of the cat walk connected to the transport vehicle, the hand rail capable of rotational and axial movement relative to the cat walk; and
a locking device for restricting the rotational and axial movement of the hand rail relative to the cat walk when in a locked position.

12. The apparatus as defined in claim 8, further comprising:
a volume control port positioned in and extending through an outer surface portion of the bulk container;
a volume control header; and
a volume control line connected to and extending from the volume control port and into the volume control header for collecting fluid from the bulk container when the fluid level inside the bulk container reaches the volume control port.

13. A method of reclaiming waste water, the method comprising:
(a) mounting at least one filtration module on a transport vehicle, the at least one filtration module having a bulk container, a plurality of treatment vessels positioned within the container and connected to a waste water inlet header, a produced water collection header, and a waste water outlet header, each of the plurality of treatment vessels having a treatment media positioned therein;
(b) moving the transport vehicle to a water reclamation site;
(c) flowing waste water into the waste water inlet header, thereby distributing the waste water into the plurality of treatment vessels;
(d) engaging the waste water with the treatment media in the plurality of treatment vessels, thereby filtering the waste water;
(e) collecting the produced water from each of the plurality of treatment vessels in the produced water collection header; and
(f) collecting the waste water from each of the plurality of treatment vessels in the waste water outlet header.

14. A method as defined in claim 13, wherein the transport vehicle further comprises:
at least one cat walk assembly positioned around the outer perimeter of the transport vehicle, the cat walk assembly being capable of movement between a transport position, an operational position, and an access position; and wherein the method further comprise after step (b), but before step (c):
moving the cat walk assembly from a transport position to an operational position.

15. A method as defined in claim 14, wherein the cat walk assembly further comprises:
a cat walk rotatably connected to the transport vehicle;
a retractable support bar outwardly extendable from the transport vehicle;
a hand rail, rotatably connected to the cat walk and axially movable relative to the cat walk when in an unlocked position; and
a locking device for restricting the rotational and axial movement of the hand rail relative to the cat walk; and wherein the method further comprise after step (b), but before step (c):
extending the support bar outwardly from the transport vehicle;
disengaging the locking device;
rotating the cat walk into abutting contact with the support bar;
rotating and axially moving the hand rail relative to the cat walk to an upright position; and
engaging the locking device, thereby locking the cat walk assembly in an operational position.

16. A method as defined in claim 15, wherein the method further comprises after step (f):
retracting the support bar inwardly into the transport vehicle;
disengaging the locking device;
rotating the cat walk to an upright position;
rotating and axially moving the hand rail relative the cat walk to a position parallel with the cat walk;
engaging the locking device, thereby locking the cat walk assembly in a transport position; and
moving the transport vehicle away from the water reclamation site.

17. A method as defined in claim 13, wherein the filtration module further comprises a chemical treatment header; and wherein step (d) further comprises:
flowing chemical treatment from a chemical treatment reservoir and into the chemical treatment header, thereby distributing the chemical treatment into the plurality of treatment vessels.

18. A method as defined in claim 13, wherein step (c) further comprises:
pumping waste water from a waste water reservoir and into the waste water inlet header.

19. A method as defined in claim 18, wherein step (f) further comprises:
pumping the waste water from the waste water outlet header and back into the waste water reservoir.

20. A method as defined in claim 13, wherein step (e) further comprises:
pumping produced water from the produced water collection header and into a produced water reservoir.
